(19) United States
(12) Patent Application Publication
(10) Pub. No.: US 2024/0335989 A1
(43) Pub. Date: Oct. 10, 2024

(54) SPECIALIZED POOL COUPLINGS FOR EASY MAINTENANCE

(71) Applicant: Alin Eduard Grecea, East Stroudsburg, PA (US)

(72) Inventor: Alin Eduard Grecea, East Stroudsburg, PA (US)

(21) Appl. No.: 18/590,049

(22) Filed: Feb. 28, 2024

Related U.S. Application Data
(60) Provisional application No. 63/457,856, filed on Apr. 7, 2023.

(51) Int. Cl. B29C 45/26; B29C 64/118; B29C 64/129; B29C 64/153; B29C 64/35; B29L 31/24; B33Y 10/00

(52) U.S. Cl. CPC B29C 45/261; B29C 64/118; B29C 64/129; B29C 64/153; B29C 64/35; B33Y 10/00; B29L 2031/24; B29L 2031/246

(57) ABSTRACT

T Split Hose, the Y Split Hose and the Cross Split hoses manufactured for the purpose of specialized pool couplings for easier maintenance. The device allows for the simple coupling through the threaded ends of new devices made for the same style and circumference of threads. Furthermore, water chlorinators, saltwater systems, and solar water heaters may be added and easily serviced with the use of the T Split Hose, Y Split Hose, and Cross Split hose.

### RELATED APPLICATIONS

This application claims benefit to provisional application US 63/457,856 filed on Apr. 7, 2023 and is incorporated in its entirety.

### FIELD OF THE INVENTION

The present subject matter relates generally to swimming pools, spas and pool pumps Unions, joins or couplings or PVC plumbing Joins for quick assembly and disassembly and quick serviceability of Swimming Pools, Spas or fluid pumps or swimming pool pumps and spas.

### BACKGROUND OF THE INVENTION

Most swimming pool spas, above ground pools, pool pumps and pools use unions and couplings which are threaded for quick service assembly and disassembly. To support repeatable serviceability and quick interchangeability of joins unions and couplings, L ring gaskets are used to prevent fluid leaks and drips.

Unlike like PVC plumbing couplings and pipes, the assemblies need servicing and cannot be permanently joined with glues, resins or cements. Swimming Pool spas and above ground pools are designed with two ports of water evacuation into the pump to prevent skin and hair injuries to people using said swimming pools.

If a swimming pool user's skin or hair is sucked through one water evacuation orifice or the hole is covered by a swimming pool user skin, the additional uninhibited orifice will balance the suction preventing injuries to the swimming pool user. Both water evacuation orifices need to be joined with a 3-way T or a Y or a cross (+) shaped pipe reducing the hoses from 2 to 1, then the 1 hose needs to be connected into the pump which circulates the water or fluid through the system.

The two connecting hoses on the T pipe are usually of smaller circumference than the 3rd hose which connects into the swimming pool pump or spa pump. This causes numerous problems when attempting to connect new developed apparatuses for improving the water quality or chlorination or saltwater systems and pool vacuums adding expensive contraptions for adapting these new systems to existing swimming pools and pool spas.

In addition, running the current systems with a limited water flow increases the cost of operation of the swimming pools and pool spas.

### PRIOR ART

In prior art the water flow is much more limited compared to the present subject matter. This leads to increased operating cost and increased service time of the pool pump because of the extended time duration to circulate the water volume of an entire pool.

In prior art the coupling of new apparatuses like chlorinators or salt water systems is nearly impossible because the couplings or unions are non-existent or if they exist, they have to be manually made from bits and pieces that need to be purchased, cut, filed and assembled, glued with resins or cements which are prone to failure more often than not.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present subject matter reduces the financial and time expenses of operating and maintaining a pool. In addition, it allows for the simple coupling through the threaded ends of new devices made for the same style and circumference of threads.

In some embodiments, the present subject matter allows for multiple devices to be staggered in the water/fluid cycle to improve the quality of water and the temperature. Water chlorinators and saltwater systems can be added to pools and spas. Solar Water heaters can be added easily and serviced easily with the help of the present subject matter.

The present subject matter overcomes the limited waterflow problem by making the T or Y or the cross pipe ends of the same circumference. In addition, all 3 or 4 ends are threaded allowing for quick serviceability of the system.

The edges or ends of the T split Hose, Y split hose and Cross Pipe are smooth and flat to allow the formation of a proper seal as the gaskets are compressed through threading onto the flat edges of the pipes.

Moreover, the threaded ends allow for an exceptional compression of the L ring seals or gaskets to prevent leaks or drips. Having the same threaded end allows for standardization through threaded couplings and 1 ring gaskets rather than non-threaded t pipes with collars.

The stacking of multiple 3 ended or 4 ended Joints, or Pool union pipes allow for implementing additional permanent fixtures like swimming pool vacuums, water chlorinators or salt water systems while reducing cost, time and human intervention while maintaining and operating the system.

In some embodiments, A method of Producing the T Split Hose, A Y Split Hose and A Cross Split hose with injection molding is used. A mold can have one or more cavities composed of a and b dies plates and retractable rods which move about for the creation of the T, Y and Cross pipe wherein the edges are smooth and flat. Each of these T, Y, and Cross pipes are produced as “complete parts” without the need for further assembly.

When dies and rods are in the enclosed position molten plastic (PVC, Polycarbonate, ABS, PETG, Nylon, PCTG and other such materials that can be molded) is injected to take the shape of the of the empty space provisioned by a and b dies in conjunction with mobile sliding rods.

Mold dies are separated/opened, and the mobile rods are retracted and then the pistons can push the newly formed part to be ejected allowing for the system to begin a new cycle for forming the next part or parts. This process can be repeated as often is required for the job.

The present subject matter comprises of a method of mass producing the T Split Hose, the Y Split Hose and the Cross Split hose with 3d printing Fused Deposition Modeling.

In the interest of keeping costs down and minimizing failures the T, Split and Cross split hose are designed as interlocking pieces that assemble in the final shape. This reduces the time for fused deposition 3d printing by removing the need of supports and their removal.

In some embodiments, the present subject matter comprises of a method of producing the T Split Hose, the Y Split Hose and the Cross Split hose with Resin 3d Printing in Liquid Resin also known as Stereolithography.

The stereolithography process keeps costs to a minimum as well as time for manufacturing and to minimize the need for supports in 3d printing with liquid resin.

In some embodiments, the T Split hose is redesigned as two or more parts and finally assembled into the final shape for use.

The present subject comprises of a method of mass producing the T Split Hose, the Y Split Hose and the Cross Split hose with 3d printing sintering. With Sintering 3d printing all variations can be 3d printed in all combinations because with sintering the entire volume of the 3d printer itself can be filled with dust which acts as supports but only selectively the plastic dust is fused under the instructions of the slicing software.

The hardened parts then are removed from the plastic dust, cleaned and sent to the next stage of manufacture. Sintering 3d printing can obtain similar results as injection molding from the same designs.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable.

Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

### DETAILED DESCRIPTION OF FIGURES

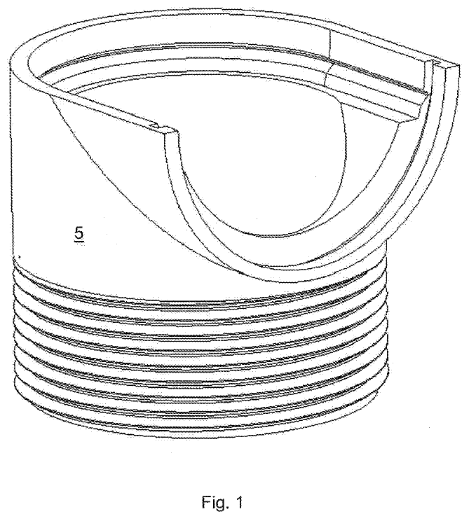

FIG. 1 shows a perspective view of an interlocking, bottom assembly 5 of a T pipe connector that is produced by using fused filament fabrication or fused deposition modeling 3d printing.

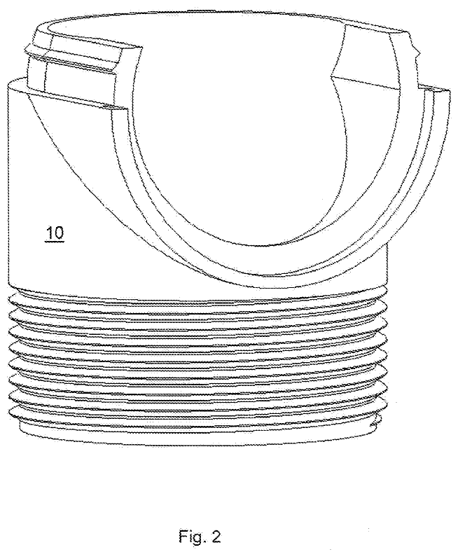

FIG. 2 shows a perspective view of an interlocking top assembly 10 of the T pipe connector that is produced by using fused filament fabrication or fused deposition modeling 3d printing.

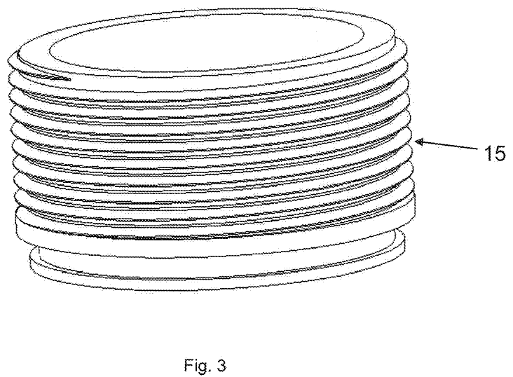

FIG. 3 shows a perspective view of an interlocking T pipe tail 15 produced by fused filament fabrication or fused deposition modeling 3d printing. The top assembly 10 and bottom assembly 5 are then affixed to the T pipe tail to form the complete T pipe.

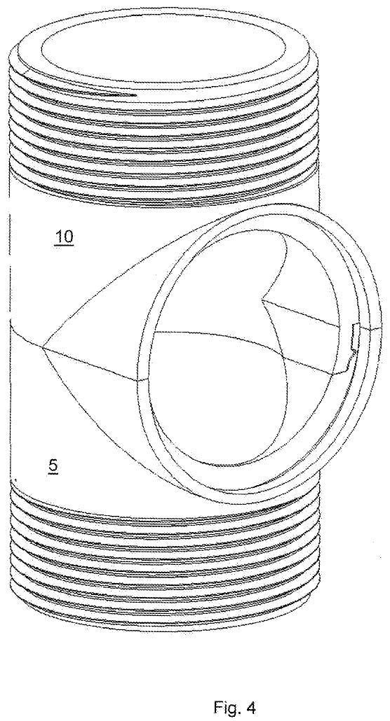

FIG. 4 shows a perspective view of how the top assembly 10 and bottom assembly 5 of the T pipe interlocks without the tail piece.

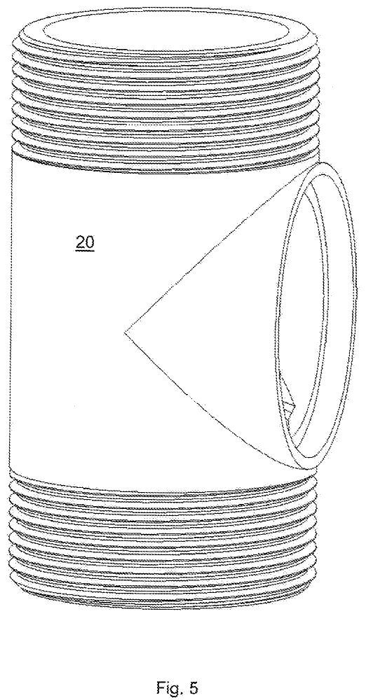

FIG. 5 shows a perspective view of the T tube 20 when produced with liquid resin using 3d printing stereolithography.

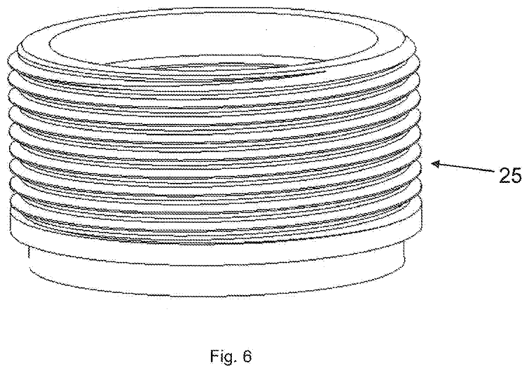

FIG. 6 shows a perspective view of the T pipe tail 25 when produced with stereolithography. T tube 20 and T pipe tail 25 are then affixed to each other using liquid resin cured with UV light.

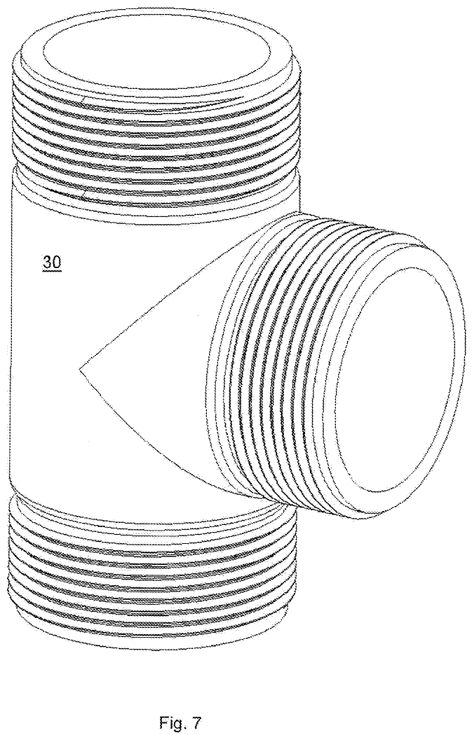

FIG. 7 shows a perspective view of the injection molding produced T pipe 30.

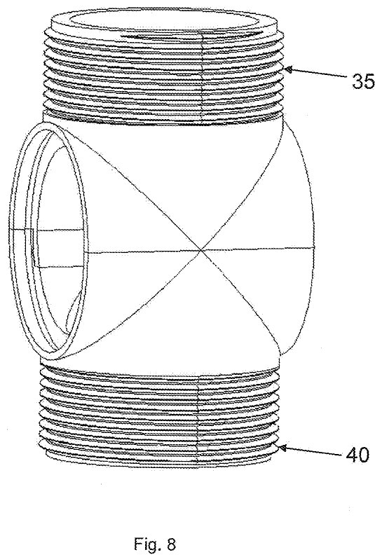

FIG. 8 shows a perspective view of the interlocking top assembly 35 and bottom assembly 40 affixed to each other after being printed using fused filament fabrication or fused deposition modeling. This assembly is the beginning of forming an interlocking cross pipe 55.

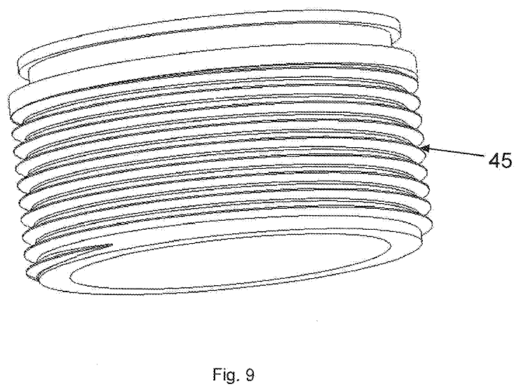

FIG. 9 shows a perspective view of an interlocking cross pipe tail assembly 45 which is printed using fused filament fabrication or fused deposition modeling.

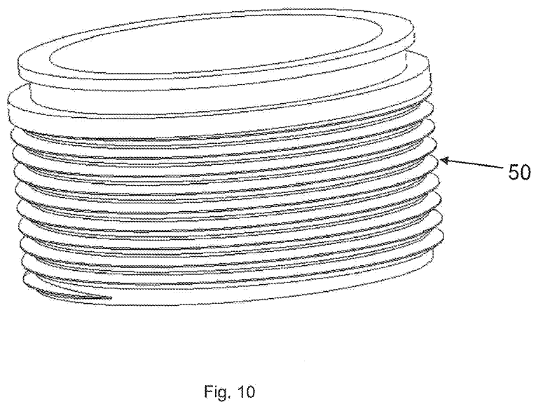

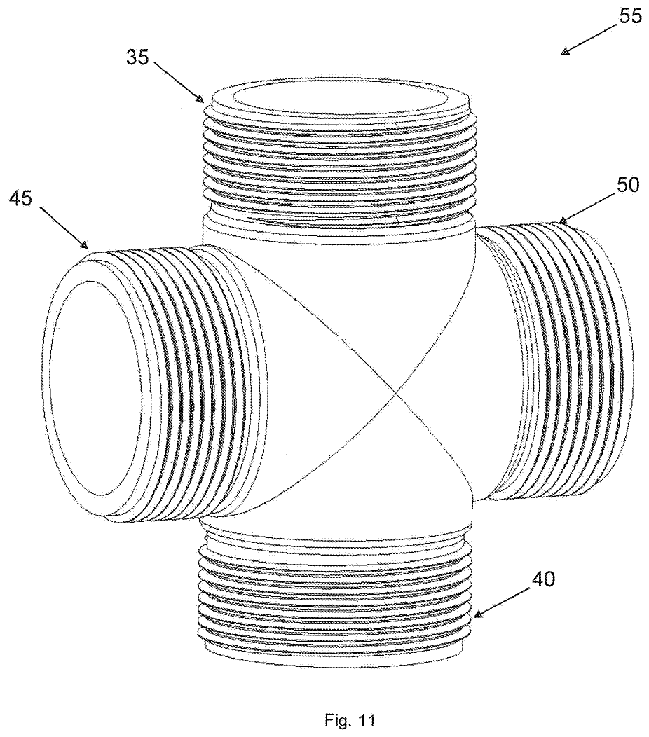

FIG. 10 shows a perspective view of an interlocking cross pipe tail assembly 50 which is printed using fused filament fabrication or fused deposition modeling. Cross pipe tail assemblies 45, 50 affix into the top and bottom assemblies 35. 40 to create the interlocking cross pipe 55 as seen in FIG. 11.

FIG. 11 shows a perspective view of an interlocking cross pipe 55 created be either injection molding, fused filament fabrication, or fused deposition modeling.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

We claim:

1. A method of using the T Split Hose, Y Split Hose and Cross Split hose with injection molding comprising of:
a) A mold having one or more cavities composed of a and b dies plates and retractable rods which move about for the creation of the T, Y and Cross pipe wherein the edges are smooth and flat, and wherein each T, Y, and Cross pipes are produced as “complete parts” without the need for further assembly;
b) When dies and rods are in the enclosed position molten plastic (PVC, Polycarbonate, ABS, PETG, Nylon, PCTG and other such materials that can be molded) is injected to take the shape of the of the empty space provisioned by a and b dies in conjunction with mobile sliding rods;
c) Mold dies are separated/opened, and the mobile rods are retracted and then the pistons can push the newly formed part to be ejected allowing for the system to begin a new cycle for forming the next part or parts.

2. A method of using the T Split Hose, the Y Split Hose and the Cross Split hose as in claim 1, wherein T, Split, and Cross Split hose are designed as interlocking pieces.

3. A method of using the T Split Hose, the Y Split Hose and the Cross Split hose as in claim 1, wherein the interlocking pieces 5, 10 reduces the time required by removing the need of supports and their removal, but requires the manual assembly of the interlocking pieces.

4. A method of using the T Split Hose produced with injection molding as in claim 1, wherein T-Pipe 30 is made from a single piece without further need of assembly.

5. A method of using the T Split Hose, the Y Split Hose and the Cross Split hose with Resin 3d Printing in Liquid Resin also known as Stereolithography.

6. A method of using the T Split Hose, the Y Split Hose and the Cross Split hose with Resin 3d Printing in Liquid Resin also known as Stereolithography as in claim 5, wherein the T split Hose, the Y Split Hose, and Cross Split hose are designed as two or more parts before final assembly.

7. A method of using the T Split Hose, the Y Split Hose and the Cross Split hose with Resin 3d Printing in Liquid Resin also known as Stereolithography as in claim 5, wherein liquid resin is used to minimize the need for supports.

8. A method of using T Split Hose produced with Resin 3d Printing in Liquid Resin also known as Stereolithography as in claim 5, wherein T tube 20 and T pipe tail 25 affixed to each other using liquid resin cured with UV light.

9. A method of using the T Split Hose, the Y Split Hose and the Cross Split hose with 3d printing sintering.

10. A method of using the T Split Hose, the Y Split Hose and the Cross Split hose with 3d printing sintering as in claim 9, wherein all variations of the T Split Hose, The Y Split Hose, and the Cross Split hose may be selectively combined together.

11. A method of using the T Split Hose, the Y Split Hose and the Cross Split hose with 3d printing sintering as in claim 9, wherein the entire volume of the 3d printer is filled with dust which acts as supports.

12. A method of using the T Split Hose, the Y Split Hose and the Cross Split hose with 3d printing sintering as in claim 9, wherein the plastic dust is fused via instructions of the slicing software.

13. A method of using the T Split Hose, the Y Split Hose and the Cross Split hose with 3d printing sintering as in claim 9, wherein the hardened parts are removed from the plastic dust, cleaned, and sent to the next stage of manufacturing.

14. A method of using T Pipe connector made from 3d fused filament fabrication or fused deposition modeling 3d printing.

15. A method of using T Pipe connector made from 3d fused filament fabrication or fused deposition modeling 3d printing as in claim 14, wherein a bottom assembly 5 and top assembly 10 are affixed to each other.

16. A method of using T Pipe connector made from 3d fused filament fabrication or fused deposition modeling 3d printing as in claim 14, wherein T Pipe tail connector 15 are affixed to one another to form a complete T Pipe.

17. A method of using the Interlocking Cross Pipe made from 3d fused filament fabrication or fused deposition modeling 3d printing as in claim 14, wherein top assembly 35 and bottom assembly 40 are affixed to each other using specialized cutouts and ridges.

18. A method of using the Interlocking Cross Pipe made from 3d fused filament fabrication or fused deposition modeling 3d printing as in claim 14, wherein interlocking cross pipe tail assembly 45 and interlocking cross pipe tail assembly 50 are affixed to top assembly 35 and bottom assembly 40 to form interlocking cross pipe 55.
